(19) United States
(12) Patent Application Publication
(10) Pub. No.: US 2019/0170517 A1
(43) Pub. Date: Jun. 6, 2019

(54) INDOOR POSITIONING AND RECORDING SYSTEM AND METHOD

(71) Applicant: J2SQUARE LLC, Burlington, NJ (US)

(72) Inventor: Fernando J. Pinho, Burlington, NJ (US)

(21) Appl. No.: 16/205,551

(22) Filed: Nov. 30, 2018

Related U.S. Application Data
(60) Provisional application No. 62/594,156, filed on Dec. 4, 2017.

(51) Int. Cl. G01C 21/20; G06Q 10/06; H04W 4/33; H04M 1/02; H04W 4/024; G01C 21/16

(52) U.S. Cl. CPC G01C 21/206; G06Q 10/063114; H04W 4/33; H04M 2250/12; H04W 4/024; G01C 21/16; H04M 1/0202

(57) ABSTRACT

An improved positioning and navigational system for indoor use providing reliable positioning signals, other than by use of signals from the global positioning system, in a cost effective manner for use in construction projects, in the building trades, and inspection businesses, activities that relate to using surveys, floorplans, and blueprints, and security systems for a variety of buildings, such as schools, government buildings, apartment buildings, and office buildings.

### CROSS REFERENCE TO RELATED APPLICATION

This application claims priority from U.S. Provisional Application No. 62/594,156 filed on Dec. 4, 2017, and follows on U.S. Provisional Applications Nos. 62/352,598 and 62/423,349 filed on Jun. 21, 2016 and Nov. 17, 2016 respectively and pending U.S. Utility application Ser. No. 15/628,700 filed on Jun. 21, 2017, all of which being incorporated by reference herein.

### FIELD OF THE INVENTION

The present invention relates positioning systems for indoor use including: (i) systems for use in construction projects, in the building trades, and inspection businesses; (ii) activities that relate to using surveys, floorplans, and blueprints, and (iii) security systems for a variety of buildings, such as schools, government buildings, apartment buildings, and office buildings, as well as to a panoply of other uses that require tracking, security, and related tasks in interior spaces.

### BACKGROUND OF THE INVENTION

While systems based on satellite-based radio navigation system known as the Global Positioning System, or GPS, are used in a wide variety of applications, GPS-based indoor positioning applications suffer from the limited reception of the relatively weak signals that emanate from distant satellites within solid structures, to say nothing of tunnels, or even under dense cloud cover. The problem to be solved by the instant invention is to provide reliable positioning signals, other than by use of GPS, within solid structures in a cost effective manner. While indoor systems that require a panoply of expensive, ubiquitous, and redundant hardware platforms are in use in the public domain, the present invention is based on a self-contained, cost effective system that eschews such redundant, and hardware dependent, systems, such as beacons. That invention is based on the use of cost effective, limited hardware, that is, the use of a portable, electronic device, an indoor navigation device, or “IND,” in conjunction with a smartphone running an application program keyed to the structure involved, such as the program outlined in the co-pending utility application referenced hereinabove.

### SUMMARY OF THE INVENTION

The indoor navigation device, or IND, of the present disclosure is a portable electronic device, smaller in size than a handheld, specifically developed for indoor navigation and positioning in situations in which there is limited or no access to signals emanating from the Global Positioning System. The device is based on the use of an electromechanical unit that comprises an accelerometer, a gyroscope, and a compass described with more detail hereinbelow. The device, having its own self-contained power source, functions independently as those sensors are embedded within the device itself, and needs no external hardware accessories, such as beacons, for the device to function as a locator and positioning tool without resort to GPS signals. An embedded microprocessor in the IND processes raw sensor data from those sensors when the device is moved by the user and coordinates are continually updated for each displacement of the device. Latest sensor values are transmitted continuously through a Bluetooth® interface using Bluetooth® Low Energy technology (“BLE”) to a receiving and processing device, such as smartphone. The receiving device is Bluetooth paired with IND before starting to receive data from the sensors. Device size is minimized by the use of highly compact size of microelectromechanical (MEMS) technology that provides sensor values in direct digital formats. In this way, the entire system for indoor positioning consists only of two relatively small devices working in coordination with each other.

### BRIEF DESCRIPTION OF THE DRAWINGS

FIG. 1 is a representation of the relationship between the main components of the system of the present invention.

FIG. 2 is a block diagram showing the main components of the indoor navigation device of the present invention.

FIG. 3 is a perspective drawing of one of the components of the indoor navigation device of the present invention indicating the axes measured by such component.

FIG. 4 is a flow chart for operation of the system of the present invention.

FIG. 5 is a perspective drawing of the indoor navigation device of the present invention indicating the approximate measurements of said device.

FIG. 6 is shows the system of the present invention in use in a construction setting.

### DETAILED DESCRIPTION OF THE INVENTION

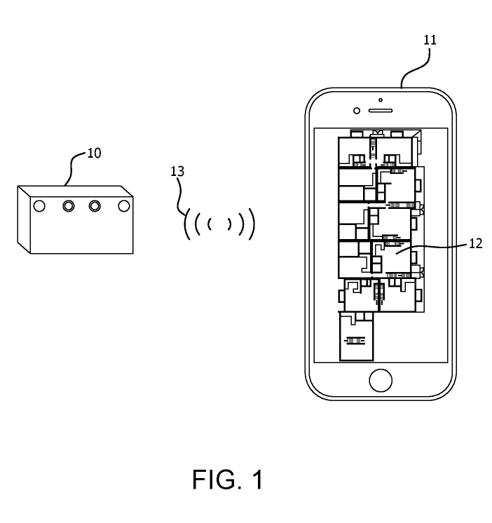

FIG. 1 shows the indoor navigation device, or IND, 10 of the present disclosure, a portable electronic device, smaller in size than a handheld, specifically developed for indoor navigation and positioning in situations in which there is limited or no access to signals emanating from the Global Positioning System. The device is based on the use of an electromechanical unit that comprises an accelerometer, a gyroscope, and compass, has a self-contained power source, and uses an embedded microprocessor to process raw sensor data from those sensors when the device is moved by the user. IND device 10 coordinates with the wireless capable handheld device 11, such as a smartphone running an application program keyed to the structure involved as shown by the electronic floor plan 12 displayed on the touchscreen of the device in FIG. 1. Sensor values are transmitted continuously via radio-frequency (RF) technology 13, such a wireless Bluetooth® interface 13 using Bluetooth® Low Energy technology (“BLE”), to the receiving and processing device, such as smartphone 11. The receiving device 11 is Bluetooth paired with IND 10, receiving an initializing signal from device 11, before starting to process data from its components. Device 10 size is minimized by the use of highly compact size of microelectromechanical (MEMS) technology that provides sensor values in direct digital formats. In this way, the entire hardware system for indoor positioning consists only of two handheld devices, IND 10 and smartphone 11, working in wireless coordination.

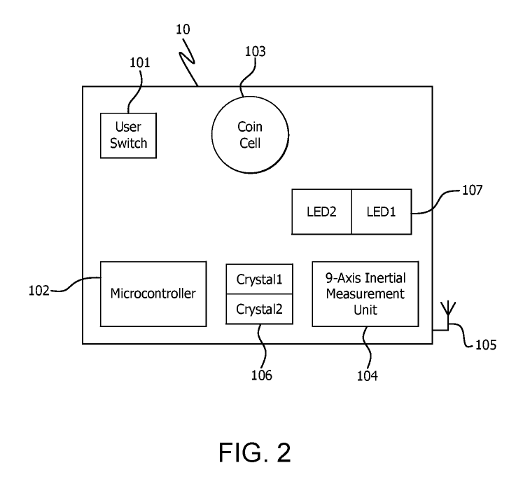

FIG. 2 is a block diagram showing the components of IND 10. User switch 101 is a push button type of switch for waking up microcontroller 102 from its power saving “sleep mode.” When this switch is pressed by the user, microcontroller 102 wakes up and, as explained below, broadcasts a wireless identification signal for discovery by receiving device 11 and waits for an initializing connection from such device 11 running the applicable electronic floorplan 12 application based on the position of the user as initialized on the touch screen of said electronic floorplan. If no connection request is received from such device 11 within ten seconds, the microcontroller 102 will go to sleep again to save power. In the preferred embodiment of device 10, the microcontroller 102 selected is chip CC2650, a wireless Micro Controller Unit (MCU) of CC26XX family of microcontrollers from Texas Instruments, which supports multiple wireless protocols in 2.4 GHz frequency range, such as BLE, ZigBee, 6LowPAN, and ZigBee RF4CE. This chip is cost-effective and power efficient for use in battery operated devices and contains 32-bit ARM Cortex-M3 operating at 48 MHz as the main processor and has rich set of peripherals. Constructed in this way, device 10 utilizes a dedicated ARM Cortex-MO for running BLE under IEEE 802.15.4 MAC protocol. This architecture improves overall system performance and power consumption and frees up flash memory for the application. The chip 102 of the preferred embodiment supports 128 kB of programmable flash, 8-kB SRAM for cache and 20 kB of Ultra-low leakage SRAM and supports peripherals like GPIOs, Timers, UART, I2C, SPI, Real Time Clock (RTC), AES-128 security module, and True Random Number Generator (TRNG).

IND 10 is powered by a self-contained power source 103, such as a 3.0 volts CR2032 coin cell battery in the preferred embodiment situated in a coin cell battery holder by which a user can insert and remove the battery easily. IND 10 is outfitted with two light signaling elements 107: LED1 is a connection indicator, that is, in the preferred embodiment, a red color SMD LED that that keeps blinking every second while device 10 waits for an initializing connection from the floorplan 12 navigator application running on smartphone 11. When a connection is established with smartphone 11, LED1 blinks 5 times with 300 milliseconds gap and goes off in the preferred embodiment. The second light signaling element in element 107 is LED2, a green color SMD LED, that blinks every time a position value is shared with the floor navigator application in receiver 11, indicating to the user the successful receipt by receiver 11 of positioning values via wireless signals 13 for processing by the floorplan 12 navigator application program.

As shown in FIG. 2, device 10 is further comprised of component element 106 which contains two crystals: crystal 1 in the preferred embodiment is an SMD type 24 MHz crystal oscillator that is used to drive the main operating clock of microcontroller chip 102 and crystal 2 is SMD type 32.768 kHz crystal oscillator that is used to drive the real time clock of the microcontroller chip 102.

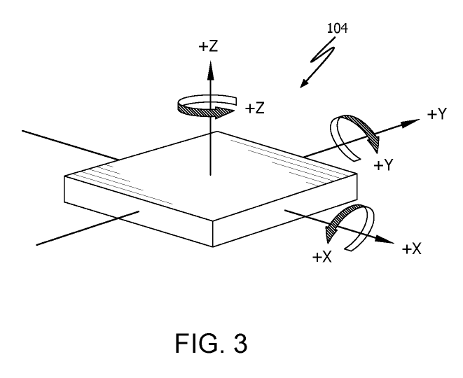

IND device 10 includes element 104, a nine-axis inertial measurement unit 104, which, in the preferred embodiment, is selected to be MPU9250, a multi-chip module that houses a 3-axis accelerometer, 3-axis gyroscope, and 3-axis magnetometer. FIG. 3 provides a view of the nine-axes that are sampled by measurement unit 104 as the X, Y, Z axes of sensitivity and polarity or rotation shown. As well as having the 3-axis gyroscope, 3-axis accelerometer, and 3-axis magnetometer, preferred chip MPU9250 provides on chip digital motion processor (DMP) and has a dedicated I2C sensor bus and MPU9250 provides complete 9-axis motion fusion output. This motion tracking device 104, with its 9-axis integration on-chip motion fusion, run-time calibration firmware eliminates costly and complex selection, qualification, and system level integration of discrete components. Preferred MPU9250 features three 16-bit analog to digital converters (ADCs) for digitizing gyroscope analog outputs, three 16-bit ADCs for digitizing accelerometer analog outputs and three 16-bit ADCs for digitizing magnetometer analog outputs. In the preferred embodiment, unit 104 (MPU9250) supports use programmable gyroscope full-scale range of ±250, ±500, ±1000 and ±2000°/sec (dps), a use programmable accelerometer full-scale range of ±2 g, ±4 g, ±8 g, and ±16 g and a magnetometer full scale range of ±4800 μT. The preferred unit 104 operates in the range of 2.4V to 3.6V. Communication with MPU9250 registers is performed using either I2C at 400 kHz or SPI at 1 MHz. The device 10 supports SPI communication at 20 MHz for the applications that requires faster communications. Unit 104, MPU9250, supports in the preferred embodiment nine different user accessible power modes of which Accel+Gyro Mode is used in this system.

Microcontroller chip 102 is provided linear acceleration and angular rotation data from the IMU 104 using an I2C communication on a periodic basis and calculates the new position based the current acceleration and rotation data and position information. The newly calculated position data as determined by microcontroller 102 is sent to the mobile application running on smartphone 11 and location then being displayed on the electronic floor map 12 of the current floor plan under navigation application running on smartphone 11.

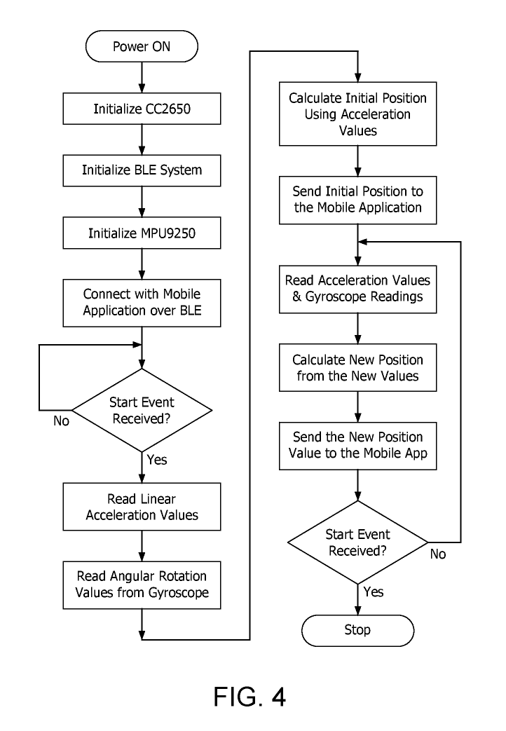

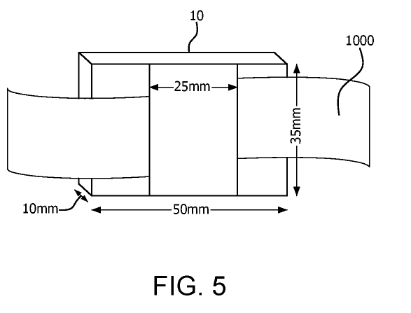

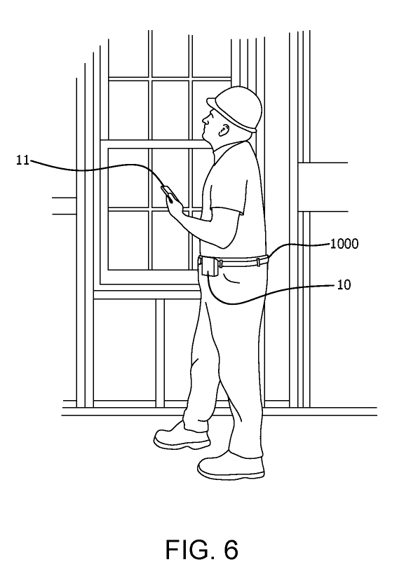

As can be appreciated by those skilled in the art, device 10 is also comprised of additional electronic components, such as a printed circuit board, resistors, capacitors, and diodes of the electronic circuitry that help in filtering noise in the power supply 103, among other things. FIG. 4 is a rear view illustrating the portability and size of IND device 10. A segment of a worker's belt 1000 is shown in FIG. 6 as having been threaded under a belt loop 1001 having a width of 25 mm. A preferred embodiment of device 10 is shown in FIG. 4 as having approximate dimensions of 50 mm in length, 35 mm in height, and 10 mm in depth, but as one can appreciate these dimensions can vary in accordance with the designer's needs and desires. FIG. 6 illustrates the invention of the present disclosure in use as device 10 as attached to belt 1000, in the preferred embodiment, of the construction worker on the job who is reviewing location and floorplan 12 information on Bluetooth-connected smartphone 11 held in his hand. By using the belt fastening concept of FIG. 5, the relative position of device 10 is maintained, aiding in accuracy of positioning. As one can appreciate, IND 10 can be fastened to the user in various manners, including, but not limited to, being attached to the shoe or lower leg of the user by appropriate fastening means.

In the disclosed system of the preferred embodiment, chip 102, the CC2650 in device 10, is configured to handle communication with unit 104, MPU9250 unit, over I2C and with mobile application over Bluetooth Smart. The MCU 102, CC2650, is also used for handling user interface actions like switch presses and provide LED indication to the users about the status of the ongoing operations. Device 10 configures unit 104 MPU9250 by writing to the control registers of chip 102 MPU9250 using I2C link and reads the data from MPU9250 using the same I2C link. Microprocessor chip 102 includes Bluetooth Smart stack in the preferred embodiment.

The flowchart of FIG. 4 illustrates the method used in coordinating the hardware of the system of the present disclosure. After being powered on, device 10 initializes all three system components: microcontroller 102, Bluetooth connectivity 13, and the inertial measurement unit 104. Device 10 waits for the position initializing ‘start’ signal from the mobile application and upon receiving the start signal, reads the accelerometer reading and gyroscope reading. The accelerometer and gyroscope readings are in direct digital values which need to be converted to ‘g’ values by multiplying the values received with 9.8 and the result will be an acceleration variable measured in meters/second squared. Based on the accelerometer readings calculate the position and send to the mobile application which, will be considered as the initial position or starting/reference point on the floor map in the mobile application. Device 10 reads the accelerometer and gyroscope readings from unit 104 in IND 10 via RF signals 13 periodically and calculates the new position based on previous position value and recent accelerometer and gyroscope readings. The new position value is sent to the mobile application for displaying it on the floor map 12. New position values are calculated and sent to the mobile application until the user presses ‘stop’ on the mobile application. The new position value is calculated based on acceleration vectors Ax, Ay, Az rotation vectors Gx, Gy, Gz. From these the resultant acceleration vector Racc and rotation vector Rgyro are calculated. New position vector Rnew is calculated using Racc and Rgyro with weights w1, w2 for accelerometer and gyroscope readings. The gyroscope weightage is taken as w2/w1 and is a value between 5 & 20 can be considered based on experimental studies. A value of 12 is considered for Gw in this system. Based on these the new position values PxNew, PyNew, PzNew are calculated and send to the mobile application. The new position values are sent to the application at the rate of one signal every ½ second. The position value updates are sent to the application until the user presses ‘stop’ on the application.

As can be appreciated, the system disclosed can be applied to many uses other than construction projects. The application software of smartphone 11 can be modified for use by authorities, businesses, individuals, and local/county/state governments. Some examples follow:
a. Identifying and making accessible plans, blueprints, layout, and configurations of buildings, properties, businesses, organizations, structures, and homes.
b. Identifying and giving access to individual handheld devices to those persons having access or permission to be in certain buildings, properties, businesses, organizations, structures, and homes. The disclosed system and method will allow for tracking the individual within said buildings and homes as disclosed in the co-pending application.
c. Using device 10 can be used as an personal identifier, key, or locator.
d. Identifying and photographing individuals having access, and storing such individual information within a database specific to a building, property, business, organization, structure, or home, including contact information such as cell phone numbers and email addresses.
e. Using a device 10 in conjunction with facial recognition software in order to:
   1. Identify authorized personnel upon entering the building or business;
   2. Track authorized personnel within the building or business;
   3. Notify authorized person entering the building or business without device 10 or with a malfunctioning device 10 that his or her device 10 is missing or improperly functioning; and
   4. Identify unauthorized personnel immediately.
      The following security applications will benefit from the use of the system of the present invention:
1. Implementation of or incorporating an option of a lock down system where no one can enter a room or building, but exiting is always accessible. Access or entry can be given by a person within the room or building, or remotely.
2. Design and manufacturing of a surveillance camera constructed under a smoke/carbon monoxide detectors or constructed to accept the smoke detector under the camera.

As can be appreciated, the disclosed system can be readily applied to planning and zoning uses by local/county/state governments, as the system can be adapted to perform the following tasks:
1. Collect, store, process, maintain, organize, update, forward, and deliver blueprints and plans to be submitted to the zoning authority or local/county/state governments for new and/or previously existing developments, sub-divisions, constructions, building lot, homes, buildings, and improvements of any properties within their boundaries or jurisdiction.
2. Process, collect, store, maintain, organize, update, forward, and deliver documents, plans, applications, reviews, and reports, submitted to or from the zoning authority or local/county/state governments that is relevant to a new or previously existing development, subdivision, construction, building lot, home, building, and improvements of any properties within their boundaries or jurisdiction.

What is claimed is:

1. A system for indoor positioning and navigation comprising:
a wireless capable electromechanical device; and
a wireless capable electronic computing device in wireless communication with said electromechanical device having a touch screen on which is displayed an indoor floorplan generated by and controlled by a software application running on such computing device,
whereby the indoor position of the user of said electromechanical device is represented by an electronically displayed marker on said floorplan, which marker automatically changes its position on said floorplan matching any change in the indoor position of said user.

2. The system of claim 1 in which said electronic computing device is a smartphone.

3. The system of claim 1 or claim 2 in which said electromechanical device comprises:
a circuit board, by which are connected the following electronic components:
a user switch;
a controller chip;
a self-contained power source;
two or more light signaling elements;
two or more crystal oscillators; and
an inertial measurement unit.

4. The system of claim 3 in which said self-contained power source is a coin cell battery.

5. The system of claim 3 in which said controller chip is a wireless microcontroller unit selected from the group of units in the model CC26XX family.

6. The system of claim 3 in which said light signaling elements are at least one red color light emitting diode and at least one green color light emitting diode.

7. The system of claim 3 in which said crystal oscillators are at least one 24 MHz crystal oscillator and at least one 32.768 kHz crystal oscillator.

8. The system of claim 3 in which said inertial measurement unit comprises:
a three axis accelerometer;
a three axis gyroscope; and
a three axis magnetometer.

9. The system of claim 8 in which said inertial measurement unit further comprises:
a digital motion processor.

10. The system of claim 9 in which said inertial measurement unit is an MPU9250 chip.

11. The system as recited in any of the claims above in which said wireless capable devices communicate via blue tooth.

12. A method for indoor building construction comprising the steps of:
scanning indoor construction documents;
uploading said scanned indoor construction documents into a wireless capable server running under the control of an application program;
having said scanned indoor construction documents labelled with positioning information by such server in communication with one or more wireless capable electronic positioning devices;
downloading said labelled scanned indoor construction documents into one or more wireless capable electronic computing devices having touchscreens held by a user or users based on the location of said user or users at said indoor construction project as determined by positioning information;
updating progress of construction work at such locations by uploading comments to said server entered by one or more users of said electronic computing devices into which such labelled construction documents have been downloaded at said indoor location;
sharing such uploaded progress information with users of said electronic computing devices;
marking a punch list of construction tasks to be performed in such project as such progress information is so uploaded; and
completing such punch list,
whereby said construction project is completed and such completion has been so recorded.

13. The method of claim 12 in which said wireless capable electronic computing devices having touchscreens are smartphones.

14. The method of claim 12 or claim 13 in which said wireless capability is blue tooth capability.

15. The methods of claim 12, 13, or 14 in which said indoor construction documents are indoor floorplans.

16. The methods as recited in any of the claims above in which said wireless capable electronic positioning devices are comprised of:
a circuit board, by which are connected the following electronic components:
a user switch;
a controller chip;
a self-contained power source;
two or more light signaling elements;
two or more crystal oscillators; and
an inertial measurement unit.

17. The methods of claim 16 in which said self-contained power source is a coin cell battery.

18. The methods of claim 16 in which said controller chip is a wireless microcontroller unit selected from the group of units in the model CC26XX family.

19. The methods of claim 16 in which said light signaling elements are at least one red color light emitting diode and at least one green color light emitting diode.

20. The methods of claim 16 in which said crystal oscillators are at least one 24 MHz crystal oscillator and at least one 32.768 kHz crystal oscillator.

21. The methods of claim 16 in which said inertial measurement unit comprises:
a three axis accelerometer;
a three axis gyroscope; and
a three axis magnetometer.

22. The methods of claim 21 in which said inertial measurement unit further comprises:
a digital motion processor.

23. The methods of claim 21 in which said inertial measurement unit is an MPU9250 chip.
